(19) United States
(12) Patent Application Publication
(10) Pub. No.: US 2006/0023984 A1
(43) Pub. Date: Feb. 2, 2006

(54) Bearing apparatus for a driving wheel of vehicle

(76) Inventors: Hiroki Terada, Shizuoaka-ken (JP); Takayasu Takubo, Shizuoka-ken (JP); Yasuhiro Aritake, Shizuoka-ken (JP)

Correspondence Address: HARNESS, DICKEY & PIERCE, P.L.C., P.O. BOX 828, BLOOMFIELD HILLS, MI, 48303, US

(21) Appl. No.: 11/190,023

(22) Filed: Jul. 26, 2005

(30) Foreign Application Priority Data
Jul. 27, 2004 (JP) 2004-218832

(51) Int. Cl. F16C 13/00; F16C 41/04; F16C 32/00

(52) U.S. Cl. 384/544

(57) ABSTRACT

A bearing apparatus for a vehicle driving wheel which prevents generation of stick-slip noise as well as fretting wear to improve durability of the bearing apparatus has an outer member (10) formed with double row outer raceway surfaces (10a, 10a) on its inner circumferential surface. An inner member (1, 27) is formed with double row inner raceway surface (2a (24a), 3a) opposite to the double row outer raceway surfaces (10a, 10a). Double row rolling elements (6) are freely rollably maintained between the outer and inner raceway surfaces (10a, 10a; 2a (24a), 3a), respectively, of the outer and inner member (10; 1, 27). A constant velocity universal joint (11, 26), for torque transmission, is inserted into the inner member (10; 1, 27). The constant velocity universal joint abuts and is axially separably connected to the inner member via a nut (19). The end surface (13a, 23a, 28a) of a shoulder (13, 28) of an outer joint member (15, 29) and an end surface of the inner member (1, 27) are previously formed so that these end surfaces line contact with each other at a vertex formed by inclined surfaces on the end of the inner member (1,27).

### CROSS-REFERENCE TO RELATED APPLICATION

This application claims priority to Japanese Patent Application No. 2004-218832, filed Jul. 27, 2004, which application is herein expressly incorporated by reference.

### FIELD OF THE INVENTION

The present invention relates to a bearing apparatus to support a driving wheel of a vehicle, such as an automobile, and more particularly, to a bearing apparatus for a driving wheel of a vehicle for rotatably supporting a driving wheel (i.e. a front wheel of FF vehicle, a rear wheel of FR or RR vehicle, and front and rear wheels of 4 WD vehicle) relative to a suspension apparatus.

### BACKGROUND OF THE INVENTION

A power transmitting apparatus of a vehicle is required not only to transmit power from an engine to a wheel, but, to enable radial and axial displacements or momentum displacement of the wheel caused by vehicle bound during rolling on a rough road or during turning of the vehicle. Accordingly, one end of a driving shaft arranged between the engine and the driving wheel is connected to a differential gear unit via a sliding type constant velocity universal joint. The other end is connected to the driving wheel via a bearing apparatus for a driving wheel which includes a non-sliding type constant velocity universal joint.

Several types of bearing apparatus for a driving wheel of vehicle are proposed, and one of the known types is shown in FIG. 6. The bearing apparatus for a driving wheel 50 includes a wheel hub 51 adapted to mount a driving wheel (not shown) at one end. A double row rolling bearing 52 rotatably supports the wheel hub 51. A non-sliding type constant velocity universal joint 53 transmits power from the drive shaft (not shown) to the wheel hub 51.

The wheel hub 51 has an integrally formed wheel mounting flange 54. The wheel hub 51 has an inner raceway surface 51a formed on its outer circumferential surface. Also, the hub 51 has a cylindrical portion 51b axially extending from the inner raceway surface 51a. The double row rolling bearing 52 has an outer integrally formed member 55 with a body mounting flange 55b on the outer circumferential surface and a double row outer raceway surfaces 55a and 55a on the inner circumferential surface. An inner member 57 is adapted to be inserted into the outer member 55 via double row rolling elements (balls) 56 and 56 contained within the outer member 55.

The inner member 57 includes the wheel hub 51, and an inner ring 58 press-fit onto the axially extending portion 51b of the wheel hub 51. The inner ring 58 has an inner raceway surface 58a on its outer circumferential surface. The inner ring 58 is axially immovably secured by a caulked portion 51c. The caulked portion 51c is formed by radially outwardly plastically deforming the end portion of the axially extending portion 51b of the wheel hub 51.

The constant velocity universal joint 53 has a mouth portion 59, and an outer joint member 62 integrally formed with a shoulder 60 which form the bottom of the mouth portion 59. A shaft portion 61 extends from the shoulder 60. The outer joint member 62 is inserted into the inner member 57 (wheel hub 51) in a manner which enables torque transmission between the two. Serrations 63 are formed on the inner circumferential surface of the wheel hub 51 to mate with serrations 64 formed on the outer circumferential surface of the shaft portion 61 of the outer joint member 62. The shaft portion 61 of the outer joint member 62 is inserted into the wheel hub 51 until the shoulder 60 of the outer joint member 62 abuts the caulked portion 51c. The wheel hub 51 and the outer joint member 62 are joined together by a securing nut 66 on an external thread 65 formed on the end of the shaft portion 61. Thus, they are fastened together at a predetermined fastening torque.

It is known that a large torque is applied from the engine to the driving wheel, via a sliding type constant velocity universal joint (not shown), at low engine speed or at the start of the vehicle causing torsion on the driving shaft. Accordingly, torsion is also created in the inner member 57 of the double row rolling bearing 52 which supports the driving shaft. When the large torque is on the drive shaft, a stick-slip noise will be caused by sudden slip between the abutting surfaces of the outer joint member 62 and the inner member 57 if a circumferential gap is between the wheel hub serrations 63 and the outer joint member shaft portion serrations 64.

In order to deal with this problem, the prior art vehicle driving wheel bearing apparatus abutted a finished flat end surface of the caulked portion 51c of the wheel hub 51 against the shoulder 60 of the outer joint member 62. This makes it possible to bring a surface contact between the caulked portion 51c and the shoulder 60. This reduces the bearing stress applied to the caulked portion 51c by the fastening force of the nut 66. Accordingly, it is possible to prevent plastic deformation of the caulked portion 51c as well as loosening of the nut 66 and thus prevent the generation of the stick-slip noise due to a sudden slip between the abutting surfaces of the shoulder 60 and the caulked portion 51c (see Japanese Laid-open Patent Publication No. 5404/1999).

However, in the bearing apparatus of the prior art, a problem exists in that the end surface of the shoulder 60 is inclined due to extension of the shaft portion 61 of the outer joint member 62 when the wheel hub 51 and the outer joint member 62 are joined together by the nut 66. Due to the inclination of the end surface of the shoulder 60, a line contact exists between the abutting surfaces of the caulked portion 51c and the shoulder although the caulked portion 51c has been previously finished as a flat surface in order to maintain the surface contact between the caulked portion 51c and the shoulder 60. This causes repeating relative rotation between the caulked portion 51c and the shoulder 60 over a long term and thus cause not only stick-slip noise but rattle due to progression of fretting wear.

### SUMMARY OF THE INVENTION

It is an object of the present invention to provide a vehicle bearing apparatus for a driving wheel which reduces generation of stick-slip noise as well as fretting wear and thus improves durability of the bearing apparatus.

In accordance with the present invention, a bearing apparatus for a vehicle driving wheel comprises an outer member formed with double row outer raceway surfaces on its inner circumferential surface. An inner member is formed with double row inner raceway surfaces arranged oppositely to the double row outer raceway surfaces. Double row rolling elements are freely rollably contained between the outer and inner raceway surfaces, respectively, of the outer and inner member. A constant velocity universal joint, for torque transmission, is inserted into the inner member. The universal joint and inner member abut one another and are axially separably connected via a nut. The end surface of a shoulder of an outer joint member and the end surface of the inner member are previously formed so that these end surfaces form a line contact with each other at a vertex formed by inclined surfaces on the end of the inner member.

Since the end surfaces of the shoulder of the outer joint member inserted into the inner member abut one another and the end surface of the inner member is previously formed so that these end surfaces line contact with each other at a vertex formed by inclined surfaces on the end of the inner, these end surfaces can surface contact each other. This is because the end surface of the shoulder is inclined due to extension of the shaft portion of the outer joint member when the inner member and the outer joint member are joined together by fastening the nut. Thus, it is possible to provide a bearing apparatus for a vehicle driving wheel which can reduce and maybe prevent generation of stick-slip noise as well as fretting wear and thus improve durability of the bearing apparatus.

According to the present invention, the inner member comprises a wheel hub with a wheel mounting flange. An inner raceway surface is formed on the outer circumferential surface of the wheel hub. One inner raceway surface opposes one of the outer raceway surfaces. The wheel hub also includes a cylindrical portion axially extending from the inner raceway surface. An inner ring is press fit onto the axially extending cylindrical portion of the wheel hub. The ring has an inner raceway surface formed on the outer circumferential surface. The other inner raceway surface opposes the other outer raceway surface. The inner ring is axially immovably secured relative to the wheel hub by a caulked portion formed by radially outwardly plastically deforming the end of the axially extending cylindrical portion. The inner end surface of the caulked portion abuts the end surface of the shoulder of the outer joint member. The end surface of the shoulder of the outer joint member and the end surface of the inner member surface contact each other. This is because that the end surface of the shoulder is inclined due to extension of the shaft portion of the outer joint member when the inner member and the outer joint member are joined together by fastening the nut. Thus, it is possible to reduce the bearing stress applied to the caulked portion and to provide a bearing apparatus for a vehicle driving wheel which can reduce or prevent generation of stick-slip noise as well as fretting wear and thus can improve durability of the bearing apparatus.

It is preferable that the inner end surface of the caulked portion is formed as an inclined surface. The surface is inclined at a predetermined angle relative to a vertical surface. It is also preferable that the inner end surface of the caulked portion is formed as a substantially flat surface. The end surface of the shoulder is formed as an inclined surface. The surface is inclined at a predetermined angle relative to a vertical surface.

According to the present invention, an axially deformable length between the end surface of the shoulder and the end surface of the inner member is set within a range of 0.010˜0.015 mm. This makes it possible to effectively achieve the surface contact between the abutting surfaces of the inner member and the shoulder of the outer joint member. This is due to the fact that the end surface of the shoulder is inclined due to extension of the shaft portion of the outer joint member when the inner member and the outer joint member are joined together by fastening the nut

The bearing apparatus for a vehicle driving wheel comprises an outer member formed with double row outer raceway surfaces on its inner circumferential surface. An inner member is formed with double row inner raceway surfaces arranged opposite to the double row outer raceway surfaces. Double row rolling elements are freely rollably contained between the outer and inner raceway surfaces, respectively, of the outer and inner member. A constant velocity universal joint, for torque transmission, is inserted into the inner member. The constant velocity universal joint abuts and is axially separably connected via a nut. The end surface of a shoulder of an outer joint member and the end surface of the inner member are previously formed so that these end surfaces line contact with each other at a vertex formed by inclined surfaces on the end of the inner member. Accordingly, the end surface of the shoulder of the outer joint member and the end surface of the inner member can surface contact each other. Thus, it is possible to provide a bearing apparatus for a vehicle driving wheel which can reduce or prevent generation of stick-slip noise as well as fretting wear and thus improve durability of the bearing apparatus.

A bearing apparatus for a vehicle driving wheel comprising an outer member formed with double row outer raceway surfaces on its inner circumferential surface. An inner member includes a wheel hub having a wheel mounting flange and one inner raceway surface on its outer circumferential surface. The one inner raceway surface opposes one of the outer raceway surfaces. The wheel hub further includes a cylindrical portion axially extending from the inner raceway surface. An inner ring is press fit onto the axially extending cylindrical portion of the wheel hub. The inner ring has an inner raceway surface formed on its outer circumferential surface. The other inner raceway surface opposes the other outer raceway surface. Double row rolling elements are freely rollably contained between the outer and inner raceway surfaces, respectively, of the outer and inner member. A constant velocity universal joint, for torque transmission, is inserted into the inner member. The constant velocity universal joint abuts the wheel hub and is axially separably connected to it via a nut. The inner ring is axially immovable secured relative to the wheel hub by a caulked portion formed by radially outwardly plastically deforming the end of the axially extending cylindrical portion. The end surface of a shoulder of the outer joint member and the end surface of the inner member are previously formed so that these end surfaces line contact with each other at a vertex formed by inclined surfaces on the end of the inner member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a longitudinal section view of a first embodiment of the bearing apparatus for a vehicle driving wheel of the present invention;

FIG. 2(a) is an enlarged cross-section view of a portion of FIG. 1;

FIG. 2(b) is an enlarged cross-section view of a modification of FIG. 2 (a);

FIG. 3 is a diagrammatic view showing conditions of contact between the caulked portion and the shoulder;

FIG. 4 is a longitudinal section view of a second embodiment of the bearing apparatus for a vehicle driving wheel of the present invention;

FIG. 5 is an enlarged cross-section view of a portion of FIG. 4; and

FIG. 6 is a longitudinal section view of a prior art bearing apparatus for a vehicle driving wheel.

### DETAILED DESCRIPTION OF THE PREFERRED EMBODIMENTS

The following description of the preferred embodiment(s) is merely exemplary in nature and is in no way intended to limit the invention, its application, or uses.

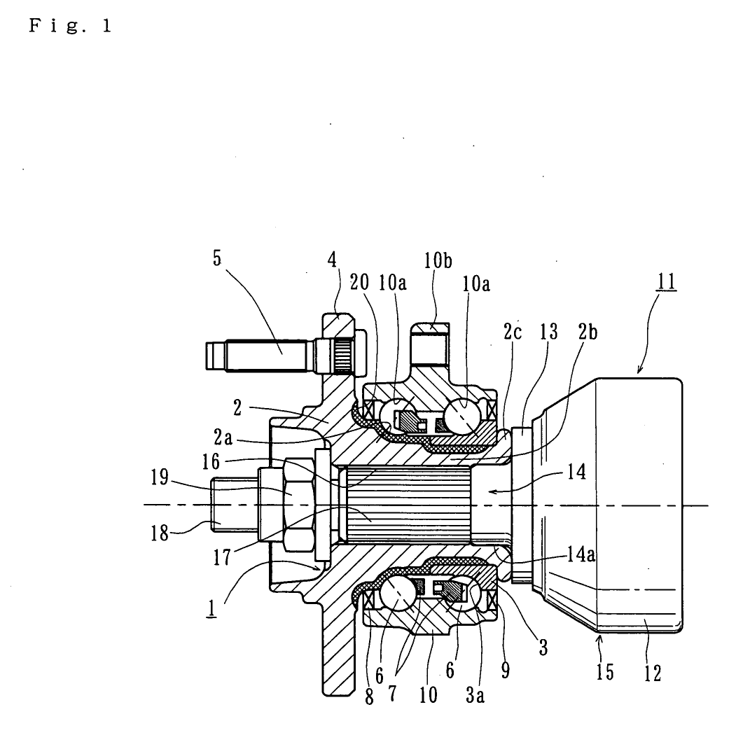

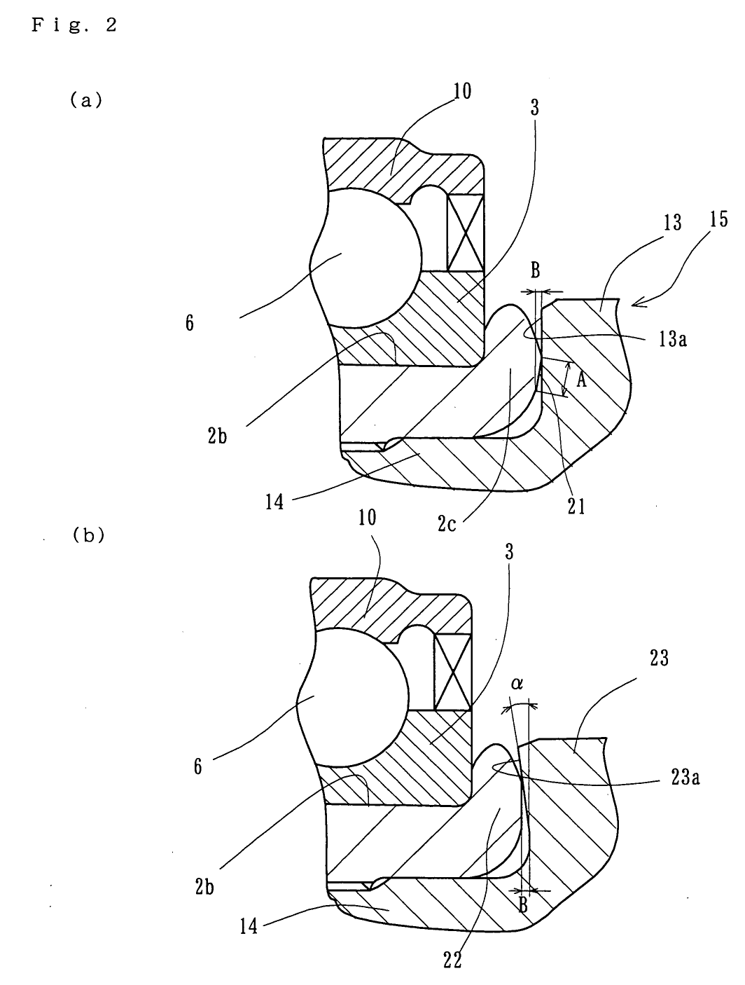

FIG. 1 illustrates a first embodiment of a bearing apparatus for a vehicle driving wheel of the present invention, FIG. 2 (a) is an enlarged view of a portion of FIG. 1, and FIG. 2 (b) is an enlarged view showing a modification of FIG. 2 (a). In the description below, the term “outboard side” (a left-hand side in drawings) of the apparatus denotes a side which is positioned outside of the vehicle body. The term “inboard side” (a right-hand side in drawings) of the apparatus denotes a side which is positioned inside of the body when the bearing apparatus is mounted on the vehicle body.

The vehicle driving wheel bearing apparatus includes an inner member 1, an outer member 10, and a double row rolling elements (balls) 6 rollably contained between the inner and outer members 1 and 10. The inner member 1 includes a wheel hub 2 and a separate inner ring 3 press-fit onto the wheel hub 2. The wheel hub 2 has an integrally formed wheel mounting flange 4 to mount a wheel (not shown) at outboard side end. Hub bolts 5 securing the wheel onto the flange 4 are arranged equidistantly along the periphery of the flange 4.

The wheel hub 2 is formed with an inner raceway surface 2a on its outer circumferential surface. An axially extending cylindrical portion 2b axially extends from the inner raceway surface 2a. An inner ring 3, formed with an inner raceway surface 3a on its outer circumferential surface, is press-fit onto the axially extending portion 2b of the wheel hub 2. The inner ring 3 is axially immovably secured by a caulked portion 2c. The caulked portion 2c is formed by radially outwardly plastically deforming the end portion of the axially extending portion 2b. This prevents the inner ring 3 from falling off the axially extending portion 2b. This embodiment adopts the third generation self-retaining structure which can control the preload without strongly fastening a nut as in a conventional manner. Thus, it is possible to easily incorporate the bearing apparatus to a vehicle and also to maintain preload for a long term period of time.

The outer member 10 includes an integrally formed body mounting flange 10b on its outer circumferential surface. The flange 10b mounts the outer member 10 on a body (not shown). Double row outer raceway surfaces 10a and 10a are formed on the outer member inner circumferential surface. The raceway surfaces 10a, 10a oppose the inner raceway surfaces 2a and 3a. Double row rolling elements 6 and 6 are freely rollably held between the outer and inner raceway surfaces 10a, 10a and 2a, 3a by cages 7 and 7. Seals 8 and 9 are arranged at the ends of the outer member 10 to prevent leakage of grease contained within the bearing as well as ingress of rain water or dusts from the outside.

The constant velocity universal joint 11 include a cup-shaped mouth portion 12 and an outer joint member 15 integrally formed with a shoulder 13. The shoulder 13 forms the bottom of the mouth portion 12. A shaft portion 14 extends from the shoulder 13. The outer joint member 15 is inserted into the inner member 1 (wheel hub 2) in a manner to enable torque transmission between the two. Serrations (or splines) 16 are formed on the inner circumferential surface of the wheel hub 2 which mate with serrations (or splines) 17 formed on the outer circumferential surface of the shaft portion 14 of the outer joint member 15. The shaft portion 14 of the outer joint member 15 is inserted into the wheel hub 2 until the shoulder 13 of the outer joint member 15 abuts the caulked portion 2c of the wheel hub 2. The wheel hub 2 and the outer joint member 15 are axially separably joined together by fastening a securing nut 19 on an external thread 18 formed on the end of the shaft portion 14. The nut 19 is fastened with a predetermined fastening torque.

The outer joint member 15 is made of medium carbon steel including carbon of 0.40˜0.80% by weight such as S53C and formed with hardened layer, having a surface hardness from about 58˜64 HRC, by high frequency induction hardening from the shoulder 13 to the shaft portion 14. The base portion 14a of the shaft portion 14 is inserted into the axially extending portion 2b via a predetermined radial gap. Thus, the base portion 14a can support the momentum load applied to the bearing apparatus.

The wheel hub 2 is made of medium carbon steel including carbon of 0.40%˜0.80% by weight such as S53C and formed with a hardened layer 20 (shown by cross-hatching in FIG. 1). The hardened layer 20 has a surface hardness of about 58˜64 HRC formed by high frequency induction hardening. The hardening occurs at the inner raceway surface 2a, a seal land portion, which contacts a sealing means 8, and the axially extending portion 2b. Such a high frequency induction hardening pattern increases the strength of the wheel hub 2 and improves the durability of the bearing apparatus. This is due to the reduction of fretting wear at the fitting surface of the inner ring 3. The caulked portion 2c remains as a no-quenching portion having a surface hardness below 25 HRC after its forging.

The inner ring 3 is made of high carbon chrome bearing steel such as SUJ2 and is hardened to its core by dip quenching to have a surface hardness of about 58˜64 HRC. The outer member 10 is made of medium carbon steel including carbon of 0.40˜0.80% by weight such as S53C. The double outer raceway surfaces 10a and 10a are hardened by high frequency induction quenching to have a surface hardness of 58˜64 HRC. In the illustrated embodiment, a double row angular ball bearing, using balls as the rolling elements is shown, however other bearing such as a double row tapered roller bearing, using tapered rollers as the rolling elements, may be adopted.

According to this embodiment, as shown as an enlarged view in FIG. 2 (a), the inner surface of the caulked portion 2c is previously formed with inclined surfaces with a vertex at their intersection. Thus, the inner surface of the caulked portion 2c line contacts the end surface 13a of the shoulder 13 at its vertex. A length “A” of the inclined surface 21 is set within a range of about 3˜5 mm. An axial depth “B” of the inclined surface 21 relative to the end surface 13a of the shoulder 13 is set within a range of about 0.010˜0.015 mm. When the wheel hub 2 and the outer joint member 15 are joined together, by fastening the nut 19, the shaft portion 14 of the outer joint member 15 is stretched and thus the end surface 13a of the shoulder 13 is inclined. Thus the abutting surfaces of the caulked portion 2c and the shoulder 13 are deformed from the line contact to the surface contact (FIG. 1). Accordingly, the bearing stress caused on the caulked portion 2c by the fastening force can be reduced. Thus, it is possible to prevent plastic deformation of the caulked portion 2c and loosening of the securing nut 19. This, in turn, helps to prevent the fretting wear and stick-slip noise.

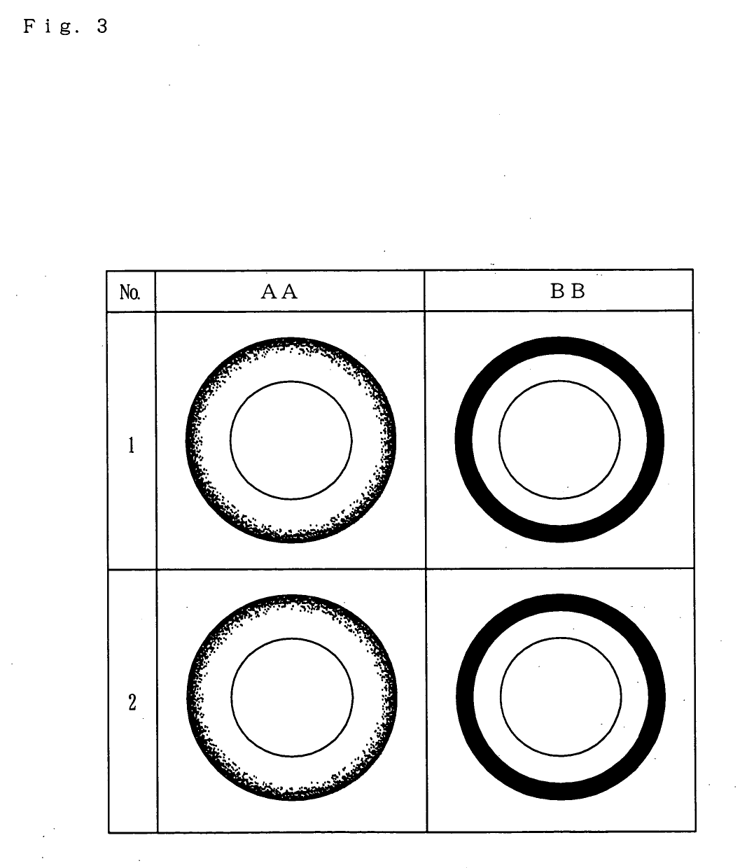

The condition of contact between the abutting surfaces of the caulked portion 2c and the end surface 13a of the shoulder 13 by fastening the nut 19 to join together the wheel hub 2 and the outer joint member 15 together was analyzed by interposing a pressure sensitive paper between the caulked portion 2c and the end surface 13a of the shoulder. The results are shown in FIG. 3. “AA” denotes a condition of hand-fastening (initial contact condition) and “BB” denotes a condition after being fastened with the fastening torque of 150 Nm. Numeral “1” denotes a sample having the axial depth “B” (FIGS. 2 (a) and (b)) of 10.5 μm, and numeral “2” denotes a sample having the axial depth “B” of 12.5 μm.

As can be seen from these results, at the initial stage, the inner end surface of the caulked portion 2c line contacts the end surface 13a of the shoulder 13 at the vertex formed by the inclined surfaces on the end of the inner member. However, substantially the whole end surface of the caulked portion 2c surface contacts the end surface 13a of the shoulder 13 after the nut 19 has been fastened at its predetermined fastening torque.

FIG. 2 (b) is a modification of the embodiment of FIG. 2 (a). In this example, the inner end surface of the caulked portion 22 is formed substantially as a flat surface. The end surface 23a of the shoulder 23 is formed as a surface inclined at a predetermined angle α relative to a vertical surface. At the initial contact stage, the end surface of the caulked portion 22 and the end surface 23a of the shoulder 23 line contact each other at the vertex of the end surface of the caulked portion 22. The axial depth “B” of the inclined surface 23a relative to the end surface of the caulked portion 22 is set within a range of about 0.010˜0.015 mm. Similarly to the previous example, when the wheel hub and the outer joint member are joined together by fastening the nut, the shaft portion 14 of the outer joint member is stretched and thus the end surface 23a of the shoulder 23 is inclined, and thus the abutting surfaces of the caulked portion 22 and the shoulder 23 contact each other.

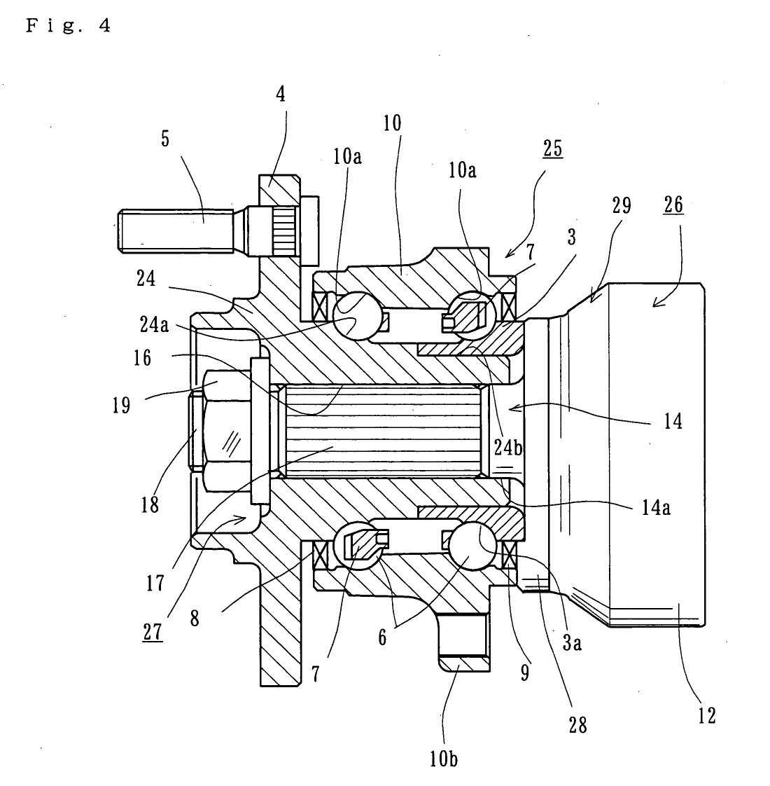

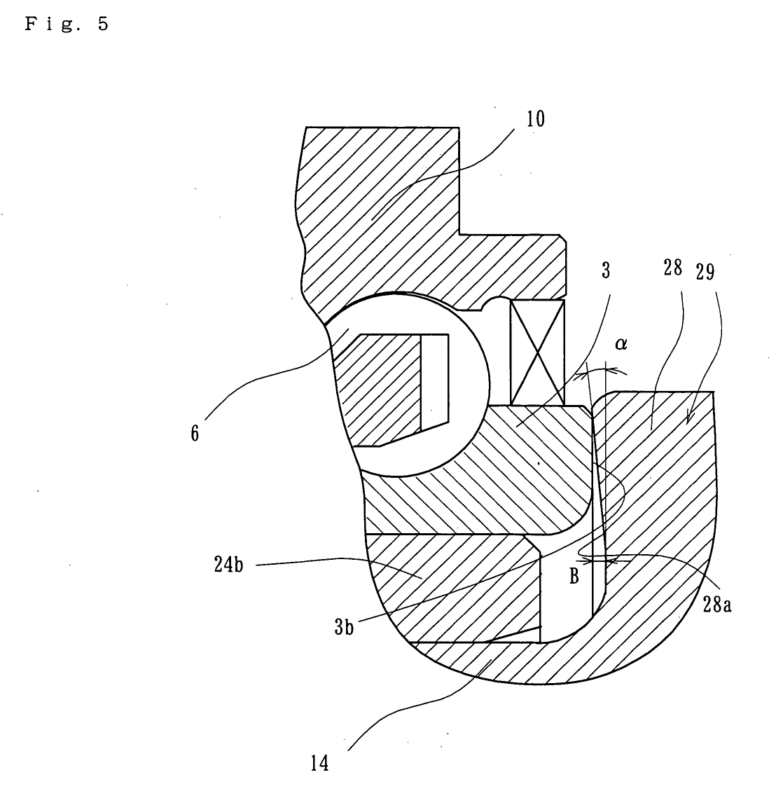

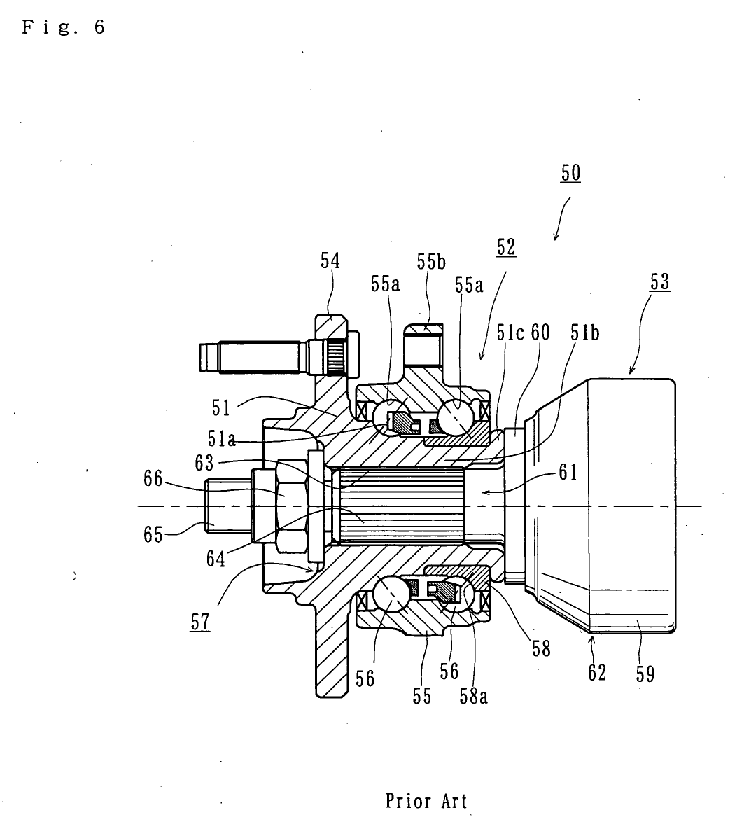

FIG. 4 is a longitudinal cross-section view of a second embodiment of the bearing apparatus for a vehicle driving wheel of the present invention. FIG. 5 is an enlarged view of a portion of FIG. 4. The same reference numerals are used to designate the same parts which have the same functions of the first embodiment.

This bearing apparatus is a so called “third generation” and includes wheel hub 24, a double row rolling bearing 25, and constant velocity universal joint 26. The double row rolling bearing 25 includes the outer member 10, the inner member 27, and a double row rolling elements 6 and 6.

The inner member 27 includes the wheel hub 24 and the inner ring 3 press-fit onto the wheel hub 24. The wheel hub 24 is made of medium carbon steel including carbon of 0.40˜0.80% by weight such as S53C. An inner raceway surface 24a is formed on the wheel hub outer circumferential surface. An axially extending cylindrical portion 24b, axially extending from the inner raceway surface 24a, is formed on the wheel hub 24.

The constant velocity universal joint 26 includes a cup-shaped mouth portion 12 and an outer joint member 29 integrally formed with a shoulder 28. The shoulder 28 forms the bottom of the mouth portion 12. A shaft portion 14 extends from the shoulder 28. The outer joint member 29 is made of medium carbon steel including carbon of 0.40˜0.80% by weight such as S53C. The outer joint member 29 is formed with a hardened layer, having a surface hardness of about 58˜64 HRC, by high frequency induction hardening. The hardening layer extends from the shoulder 28 to the shaft portion 14.

The shaft portion 14 of the outer joint member 29 is inserted into the wheel hub 24 until the shoulder 28 of the outer joint member 29 abuts the end surface of the inner ring 3. The wheel hub 24 and the outer joint member 29 are axially separably joined together by fastening a securing nut 19, with a predetermined fastening torque, on an external thread 18 formed on the end of the shaft portion 14

Similarly to the previous embodiment and as shown in FIG. 5 in an enlarged manner, the end surface 28a of the shoulder 28 is formed as an inclined surface at a predetermined angle a relative to a vertical surface. At the initial contact stage, the inner end surface 3b of the inner ring 3 and the end surface 28a of the shoulder 28 line contact each other at the vertex of the corner edges of the end surfaces 3b and 28a. The axial depth “B” of the inclined surface 28a of the shoulder 28 relative to the inner end surface 3b of the inner ring 3 is set within a range of about 0.010˜0.015 mm. Similarly to the previous example, when the wheel hub and the outer joint member are joined together by fastening the nut, the shaft portion 14 of the outer joint member is stretched. Accordingly, the end surface 28a of the shoulder 28 is inclined. Thus, the abutting surfaces of the inner end surface 3b of the inner ring 3 and the end surface 28a of the shoulder 28 contact each other.

The bearing apparatus for a vehicle driving wheel of the present invention can be applied to all of the bearing apparatus of the first through third generations having double row rolling elements arranged between the outer and inner members.

The present invention has been described with reference to the preferred embodiments. Obviously, modifications and alternations will occur to those of ordinary skill in the art upon reading and understanding the preceding detailed description. It is intended that the present invention be construed as including all such alternations and modifications insofar as they come within the scope of the appended claims or their equivalents.

What is claimed is:

1. A bearing apparatus for a vehicle driving wheel comprising:
an outer member formed with double row outer raceway surfaces on its inner circumferential surface;
an inner member formed with double row inner raceway surface arranged opposite to the double row outer raceway surfaces;
double row rolling elements freely rollably maintained between the outer and inner raceway surfaces, respectively, of the outer and inner member;
a constant velocity universal joint inserted into the inner member abutting said inner member and being axially separably connected to said inner member via a nut; and
an end surface of a shoulder of an outer joint member and an end surface of the inner member are previously formed so that these end surfaces line contact with each other at a vertex formed by inclined surfaces on the end of the inner member.

2. A bearing apparatus for a vehicle driving wheel of claim 1, wherein said inner member comprises:
a wheel hub having a wheel mounting flange and one inner raceway surface formed on an outer circumferential surface of said wheel hub, said one inner raceway surface opposing one of said outer raceway surfaces and a cylindrical portion axially extending from the inner raceway surface formed on said wheel hub;
an inner ring press fit onto the axially extending cylindrical portion of the wheel hub, said inner ring including the other inner raceway surface on its outer circumferential surface, said other inner raceway surface opposing the other outer raceway surface; and
wherein the inner ring is axially immovable secured relative to the wheel hub by a caulked portion formed by radially outward plastically deforming the end of the axially extending cylindrical portion, and the inner end surface of the caulked portion abuts the end surface of the shoulder of the outer joint member.

3. A bearing apparatus for a vehicle driving wheel of claim 2, wherein the inner end surface of the caulked portion is formed as an inclined surface inclined at a predetermined angle relative to a vertical surface.

4. A bearing apparatus for a vehicle driving wheel of claim 2, wherein the inner end surface of the caulked portion is formed as a substantially flat surface, and the end surface of the shoulder is formed as an inclined surface inclined at a predetermined angle relative to a vertical surface.

5. A bearing apparatus for a vehicle driving wheel of claim 1, wherein an axially deformable length between the end surface of the shoulder and the end surface of the inner member is set within a range of about 0.010 mm to about 0.015 mm.
